(19) United States
(12) Patent Application Publication
(10) Pub. No.: US 2008/0031369 A1
(43) Pub. Date: Feb. 7, 2008

(54) Apparatus and methods for multi-carrier wireless access with energy spreading

(76) Inventors: Ye (Geoffrey) Li, Marietta, GA (US); Taewon Hwang, Atlanta, GA (US)

Correspondence Address: Robert F. Gazdzinski, Esq.;Gazdzinski & Associates, Suite 375, 11440 West Bernardo Court, San Diego, CA, 92127, US

(21) Appl. No.: 11/449,520

(22) Filed: Jun. 7, 2006

(51) Int. Cl. H04K 1/10

(52) U.S. Cl. 375/260; 375/132

(57) ABSTRACT

Apparatus and methods for conducting communication over a wireless or other network using a multi-carrier energy-spreading approach. In one embodiment, an energy-spreading technique (EST) is applied within a multi-carrier or MC-CDMA system to improve signal detection performance and diversity. Significant improvements in E_{b}/N₀ are achieved for both indoor and urban paradigms over systems without such EST capability. In another variant, a code-divided system with two transmit antennas is disclosed having a diversity code (e.g., Alamouti code) used to obtain enhanced transmit diversity. Another variant incorporates a “symbol shuffling” scheme (together with the aforementioned EST) to enhance diversity and performance. The symbol shuffling scheme and diversity code may also be combined to provide a matched filter bound (MFB) for systems with four or more antennas. Exemplary base station and subscriber (e.g., mobile) unit configurations are also disclosed, as well as system architectures implementing the foregoing.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The present invention is related to the field of wireless communications. More particularly, the present invention is directed to wireless communication using multi-carrier environments including, e.g., code division multiple access modulation with energy spreading.

2. Description of Related Technology

Numerous techniques for wireless spectral access and spectral spreading are known in the prior art. These include, for example, Direct Sequence Spread Spectrum (DSSS) and the related Code Division Multiple Access (CDMA), Frequency-hopping Spread Spectrum (FHSS), Orthogonal Frequency Division Multiplexing (OFDM), Time Division Multiple Access (TDMA), and Frequency Division Multiple Access (FDMA). The well-known Global System for Mobile Communications (GSM) systems make use of both forms of TDMA and FHSS.

Code division multiple access (CDMA) has more recently become a dominate signal processing technique for mobile communications. It was originally adopted by the telecommunications industry association (TIA) as interim standard 95 (IS-95A), and has since been adopted by the two major third generation communication standard setting bodies: the third generation partnership project (3GPP) and the third generation partnership project 2 (3GPP2).

CDMA success is due, in part, to the various advantages it provides for mobile communications. In particular, CDMA allows for frequency reuse between different cell cites as well as robust communications in a fading channel environment. Additionally, CDMA allow for features such as “soft hand-off” where a subscriber unit (such as a cellular telephone) establishes a new link with a second base station before terminating the existing link with a first base station.

Another advantage of CDMA is the ability to use “rake” receivers that process one or more multi-path instances of the original signal. These multi-path instances are created by reflections of the original signal. When the symbol duration is much larger than the delay spread of the channel, the inter-symbol interference (ISI) caused by the dispersive fading can be ignored.

However, as the data rate of CDMA communications systems increase, the symbol duration decreases. As the symbol duration approaches that of the delay spread, the ISI will degrade performance. Due to the special signaling structure in many CDMA systems, equalization and spatial-temporal process are more difficult than in TDMA or GSM systems.

Orthogonal frequency division multiplexing (OFDM) divides the entire channel into many narrow sub-channels or carriers, which are transmitted in parallel to maintain high data transmission rates and at the same time increase the symbol duration to combat the ISI. Therefore, OFDM contains attributes that would ostensibly improve the performance of a CDMA system. Thus, in order to continue to receive the benefits of the CDMA communication paradigm while also accommodating higher data rates, improved apparatus and methods are needed which utilize attributes of both systems in an efficient manner.

Numerous prior art approaches to multi-carrier CDMA (MC-CDMA) are known in the prior art. For example, U.S. Pat. No. 6,654,408 to Kadous, et al. issued on Nov. 25, 2003 and entitled “Method and system for multi-carrier multiple access reception in the presence of imperfections” discloses a multi-carrier receiver, which may be utilized for receiving MC-CDMA signals, that projects the received signal onto each subcarrier and onto a selected number of adjacent subcarriers. The signals resulting from the projection are combined and decoded to provide a decision statistic signal. The decision statistic signal is evaluated to determine an estimated bit value over each bit length in the transmitted signal. The receiver exploits the effects of imperfections in the communications channel such as fast fading, Doppler and frequency offsets and phase noise, to account for the dispersion of signal energy from a subcarrier to one or more adjacent subcarriers.

U.S. Pat. No. 6,987,747 to Mottier, et al. issued Jan. 17, 2006 and entitled “Method of assigning a spreading sequence to a user of a telecommunications network” discloses an apparatus and method for a Multi-Carrier Code Division Multiple Access (“MC-CDMA”) transmission network. In the MC-CDMA transmission network a plurality of spreading sequences are assigned to individual users from a plurality of predetermined spreading sequences. The spreading sequences are assigned to users in order to ostensibly minimize the interference created by the assignment of spreading sequences.

United States Patent Publication No. 20020181562 to Castelain, published on Dec. 5, 2002 and entitled “Equalisation method and device of the GMMSE type” discloses an equalization method for a downlink channel in a telecommunication system transmitting MC-CDMA symbols on a plurality of carrier frequencies, in which a plurality of links are established between a transmitter and a plurality of receivers in order to transmit a plurality of coded signals, each link using a distinct access code among N possible codes, the method providing that, for at least one receiver, a vector (Y) representing the components of the signal received by the receiver on the different carrier frequencies is subjected to a filtering step adapted for supplying an observable vector (Z, Z′) and the observable vector is used for effecting an estimation of the transmitted symbols according to a mean square error minimization criterion.

United States Patent Publication No. 20020186650 to Castelain, published on Dec. 12, 2002 and entitled “Equalisation method and device of the GMMSE type” discloses equalization-methods for a downlink channel in a telecommunication system transmitting MC-CDMA symbols on a plurality of carrier frequencies, in which a plurality of links are established between a transmitter and a plurality of receivers in order to transmit a plurality of coded signals, each link using a distinct access code amongst N possible codes, the conjugate product of two possible codes being proportional to a possible code or to its conjugate, the method comprising, for at least one receiver, a step of calculating a matrix (B, E) characteristic of the plurality of links, the said calculation step first of all calculating the elements of a row or a column in the characteristic matrix and deducing the other rows or the other columns by means of a permutation of the elements.

United States Patent Publication No. 20020191581 to Isson, published Dec. 19, 2002 and entitled “MC/CDMA data transmission method” discloses a method for MC-CDMA transmission of data between nodes of a network, including assigning to each node at least one spreading matrix, a set of data of at least one datum to be transmitted by a node being multiplied by the spreading matrix which is associated therewith and the product being then transmitted on a group of carriers in at least one predetermined set of samples forming at least one OFDM symbol; forming symbols to be transmitted all having the same duration, whatever the transmit node; and adding to each transmitted symbol a cyclic prefix and a cyclic suffix representing a predetermined number of samples, respectively of the end and of the beginning of the symbol.

United States Patent Publication No. 20030112787 to Mottier, published on Jun. 19, 2003 and entitled “Code allocation method in an MC-CDMA telecommunication system” discloses an invention the object of which is to decrease or avoid the distortion of an MC-CDMA signal transmitted over a reverse link channel for a given amplifier efficiency. The invention concerns a code allocation method for a mobile telecommunication system. For each of a plurality of available spreading codes or available combinations of spreading codes a value of a first variable (PAPRₖ) characteristic of the dynamic range of a modulated signal (Sₖ) is determined, and for each of a plurality of users a value of a second variable characteristic of the propagation loss incurred over the transmission channel of the user is determined. A spreading code or combination of spreading codes producing a low dynamic range is allocated to said user if the propagation loss over its transmission channel is high.

United States Patent Publication No. 20030215007 to Mottier, published Nov. 20, 2003 and entitled “Method for performing an equalisation per carrier in a MC-DMA receiver” discloses a method for performing an equalization in a MC-CDMA receiver, a symbol transmitted to said receiver being spread with a spreading sequence over a plurality (N) of carriers, the signal received by said receiver being decomposed into a plurality of frequency components (r₁), characterized by estimating relative power values on each of said carriers, calculating a plurality of equalisation coefficients (q₁) from the estimated relative power values and multiplying each of said frequency components by one of said equalization coefficients.

United States Patent Publication No. 20040028004 to Hayashi, et al. published on Feb. 12, 2004 and entitled “Radio communication system with adaptive interleaver” discloses a radio communication system with adaptive interleaving that selects between chip interleaving and bit interleaving depending upon the number of active code signals. A transmitted RF signal includes a coded information signal part and a control signal part that indicates a number of active code signals that have been combined to form the coded information signal part. MC-CDMA systems are disclosed.

United States Patent publication No. 20040066838 to Choi, et al. published on Apr. 8, 2004 and entitled “MC/MC-DS dual-mode adaptive multi-carrier code division multiple access (CDMA) apparatus and method thereof” discloses multi-carrier (MC)/multi-carrier direct sequence (MC-DS) dual-mode adaptable CDMA apparatus, the method thereof, and a computer-readable recording medium for recording a program that implements the method. The apparatus can vary the user modulation degree and the transmission repetition degree independently, and convert a spreading scheme between the time-based spreading scheme (MC-DS-CDMA) and the frequency-based spreading scheme (MC-CDMA) in a MC-CDMA system. The apparatus includes: a user signal processing unit for performing symbol modulation, repetition and spreading of bit stream for each user based on a transmission mode suitable for channel environment of each user, and generating spread chip streams for the user; a combining unit for adding up all the spread chip streams for the users; a first interleaving unit for interleaving the chip streams added up in the combining unit and generating a first interleaved stream; and a second interleaving unit for performing a second interleaving on the first interleaved stream, optionally, based on a spreading scheme selection signal which indicates a spreading scheme determined depending on system conditions and outputting a second interleaved stream.

United States Patent Publication No. 20040066839 to Choi, et al. published on Apr. 8, 2004 and entitled “Channel transmission symbol generating system on multi-carrier communication for reduction of multiple access interference, and method thereof” discloses a method for using a different symbol timing for users so as to reduce a multiple access interference component in a multi-carrier code division multiple access (MC-CDMA) system. For this purpose, the invention involves dividing the users of the MC-CDMA system into two groups and applying an offset to the symbol timing between the user groups to cause a symbol transition of the opposite user group in the middle of the symbol interval, thereby reducing the multiple access interference component included in a symbol decision variable after a chip combination.

United States Patent Publication No. 20040081227 to Lim, et al. published on Apr. 29, 2004 and entitled “System and method for spreading/despreading in multi-carrier code division multiple access” discloses a system and a method for spreading/despreading in MC-CDMA. Simple spreading and despreading procedures are provided to allow both frequency and time spreading/despreading. The system and method for spreading/despreading in MC-CDMA produce a high processing gain, frequency diversity, and multipath time diversity through two-dimensional time/frequency spreading/despreading. Moreover, the spreading/despreading system and method support a variable transmission rate by simply changing the spreading factor without changing the spreading/despreading procedure and structure.

United States Patent Publication No. 20040116077 to Lee, et al. published Jun. 17, 2004 and entitled “Transmitter device and receiver device adopting space time transmit diversity multicarrier CDMA, and wireless communication system with the transmitter device and the receiver device” discloses a receiver device adopting STTD MC-CDMA scheme, including a plurality of receive antennas, a plurality of MC-CDMA receive units for respectively converting received signals from the plurality of receive antennas into parallel signals, for respectively performing FFT of the converted parallel signals, for respectively inversely spreading transformed signals, and for respectively equalizing and combining inversely spread signals, STTD decoding units for decoding in time direction and in space direction output signals from the plurality of MC-CDMA receive units, a parallel to serial conversion unit for converting output signals from STTD decoding units into serial signals, a de-mapping unit for de-mapping output serial signals from the parallel to serial conversion unit, and a decoding de-interleaving unit for de-interleaving output signals from the de-mapping means and for decoding de-interleaved data by performing error correction.

United States Patent Publication No. 20050030925 to Salzer, published on Feb. 10, 2005 and entitled “MC-CDMA downlink transmission method” discloses a transmission method for transmitting a plurality of symbols from a base station of a MC-CDMA telecommunication system to a plurality (K) of users, each symbol (dₖ) to be transmitted to a user being spread with a coding sequence over a plurality (L) of carriers (l) to produce a plurality of corresponding frequency components, said base station being provided with a plurality (M) of antenna elements. According to the invention, each frequency component produced by a symbol of a user (k) is weighted by a plurality (M) of weighting complex coefficients to, obtain a plurality (LM) of weighted frequency components, each weighting coefficient being relative to a user (k), a carrier (l) and an antenna element (m) and said plurality of weighting coefficients being determined from estimates of the channel coefficients of the downlink transmission channels between each antenna element and each user for each carrier frequency.

United States Patent Publication No. 20050141473 to Lim, et al. published on Jun. 30, 2005 and entitled “Adaptive downlink packet transmission method in multicarrier CDMA system” discloses an adaptive downlink packet transmission method for a multicarrier Code Division Multiple Access (MC-CDMA) system. The method can allocate radio resources efficiently according to the variations of channel conditions for each user terminal, allocate transmission power appropriately according to the interference from the same cell, and minimize interference to adjacent cells. The adaptive downlink packet transmission method includes the steps of: a) estimating a signal-to-interference-and-noise ratio (SINR) in a user terminal after channel equalization and despreading by measuring a downlink pilot channel; b) measuring an average interference factor and an average noise power; and c) allocating radio resources adaptively in the central station by determining transmission slots in a transmission frame, the number of spreading codes to be used in each transmission slot, symbol energy for each spreading code, and a transmission method, until transmission slots and packets to be allocated are not available.

United States Patent Publication No. 20060083291 to Hongming; et al. published Apr. 20, 2006 and entitled “Receiver apparatus, and associated method, for operating upon data communicated in a MIMO, multi-code, MC-CDMA communication system” discloses apparatus, and an associated method, for mitigating interference introduced upon data communicated to an MIMO receiver using an MC-CDMA communication system. The dimension of the received data is reduced to a single-representation in a manner in which inter-code and inter-antenna interference is mitigated.

Despite the foregoing variety of different approaches to multi-carrier CDMA, improved apparatus and methods are needed which make use of the CDMA and OFDM paradigms while reducing inter-symbol interference and increasing data rate for a given BER (or alternatively, producing a lower BER for a constant data rate). Such improved apparatus and methods would ideally provide enhanced multiple access capabilities as well, whether in indoor or (outdoor) “urban” transmission environments, and would be adaptable for use in modern telecommunications systems such as cellular subscriber networks or WiFi/LAN applications.

### SUMMARY OF THE INVENTION

The present invention satisfies the foregoing needs by providing, inter alia, methods and apparatus for communication over a data channel such as, e.g., a wireless air interface.

In a first aspect of the invention, a method for communicating in a wireless network is disclosed. In one embodiment, the wireless network includes a base station and at least one subscriber unit, the base station transmitting at least one data stream to the at least subscriber unit, and the method comprises: energy spreading the at least one data stream to generate at least one energy spread data stream; time-frequency spreading the at least one energy spread data stream using a plurality of orthogonal spreading codes to generate at least one spread spectrum data stream; and placing the at least one spread spectrum data stream into a plurality of frequency orthogonal carriers to generate at least one orthogonal frequency division access signal.

In one variant, the method further comprises: receiving the orthogonal frequency division access signal; performing demodulation on the orthogonal frequency division access signal to generate at least one demodulated spread sample; despreading the demodulated spread sample to generate at least one symbol sample; and iteratively detecting at least one signal associated with a particular user in the at least one symbol samples.

In another variant, the method further comprises performing space-time coding on the at least one spread spectrum data stream. The space time coding is performed using, e.g., an Alamouti diversity code

In a second aspect of the invention, a method for operating a subscriber unit for receiving an energy spread multi-carrier code division multiple access signal is disclosed. In one embodiment, the method comprises: receiving the orthogonal frequency division access signal; performing OFDM demodulation on the orthogonal frequency division access signal to generate demodulated spread samples; despreading the demodulated spread samples to generate symbol samples; and iteratively detecting user signals in the set of symbol samples.

In a third aspect of the invention, a method for operating a base station transmitting a set of data streams to a set of users is disclosed. In one embodiment, the method comprises: energy spreading each data stream from the set of data streams to generate a set of energy spread data streams; time-frequency spreading the set of energy spread data streams using a set of orthogonal spreading codes to generate a set of spread spectrum data streams; and placing the set of spread spectrum data streams into a set of frequency orthogonal carriers to generate an orthogonal frequency division access signal.

In a fourth aspect of the invention, a subscriber unit for receiving an energy spread multi-carrier code division multiple access signal is disclosed. In one embodiment, the subscriber unit comprises: radio frequency down-conversion apparatus for converting a received radio frequency signal to a baseband signal; analog-to-digital conversion apparatus for converting the baseband signal to digital samples; Fourier transform apparatus for performing OFDM demodulation on the digital samples to generate demodulated spread samples; correlation apparatus for despreading the demodulated spread samples to generate symbol samples; and demodulation apparatus configured to iteratively detect user signals in the set of symbol samples. In one variant, the subscriber unit further comprises: first antenna apparatus for receiving a first RF signal; second antenna apparatus for receiving a second RF signal; and space-time decoding apparatus for processing the first RF signal and the second RF signal.

In a fifth aspect of the invention, a base station for transmitting a plurality of data streams to a plurality of users is disclosed. In one embodiment, the base station comprises: a Hadamard transform apparatus configured to energy-spread each data stream from the plurality of data streams to generate a plurality of energy spread data streams; modulation circuitry for time-frequency spreading the plurality of energy spread data streams using a set of orthogonal spreading codes to generate a plurality of spread spectrum data streams; and inverse Fourier transform circuitry for placing the set of spread spectrum data streams into a plurality of frequency orthogonal carriers to generate an orthogonal frequency division access signal.

In a sixth aspect of the invention, wireless network apparatus adapted to transmit a set of data streams to a set of user devices is disclosed. In one embodiment, the apparatus comprises: apparatus configured to energy spread each data stream from the set of data streams to generate a set of energy spread data streams; apparatus configured to time-frequency spread the set of energy spread data streams using a set of orthogonal spreading codes to generate a set of spread spectrum data streams; and apparatus configured to place the set of spread spectrum data streams into a set of frequency orthogonal carriers to generate an orthogonal frequency division access signal.

In a seventh aspect of the invention, a wireless communication system is disclosed. In one embodiment, the system comprises: at least one transmitter comprising: apparatus configured to energy spread each data stream from the set of data streams to generate a set of energy spread data streams; apparatus configured to time-frequency spread the set of energy spread data streams using a set of orthogonal spreading codes to generate a set of spread spectrum data streams; and apparatus configured to place the set of spread spectrum data streams into a set of frequency orthogonal carriers to generate an orthogonal frequency division access signal; and a plurality of receivers, each of the receivers being configured to: receive the orthogonal frequency division access signal; perform OFDM demodulation on the orthogonal frequency division access signal to generate demodulated spread samples; despread the demodulated spread samples to generate symbol samples; and iteratively detect user signals in the set of symbol samples. In one variant, the system comprises a multi-carrier CDMA (MC-CDMA) system., and the at least one transmitter comprises one of a plurality of cellular base stations within the system, and at least a portion of the plurality of receivers comprise mobile units.

In an eighth aspect of the invention, a computer-readable storage medium adapted to store data comprising a computer program is disclosed. In one embodiment, the computer program is configured to, during operation: receive a multi-carrier orthogonal frequency division access signal; perform OFDM demodulation on the orthogonal frequency division access signal to generate demodulated spread samples; despread the demodulated spread samples to generate symbol samples; and iteratively detect user signals in the set of symbol samples.

In a ninth aspect of the invention, a method of increasing the data rate within a wireless communication system adapted for transmitting a set of data streams to a set of users is disclosed. In one embodiment, the method comprises: energy spreading each data stream from the set of data streams to generate a set of energy spread data streams; time-frequency spreading the set of energy spread data streams using a set of orthogonal spreading codes to generate a set of spread spectrum data streams; and placing the set of spread spectrum data streams into a set of frequency orthogonal carriers to generate an orthogonal frequency division access signal. At least the acts of energy spreading and time-frequency spreading reduce the bit error rate (BER) for a given value of E_{b}/N₀ for the transmitted data streams.

These and other features of the invention will become apparent from the following description of the invention, taken in conjunction with the accompanying drawings.

### BRIEF DESCRIPTION OF THE DRAWINGS

FIG. 1 is a plan view of an exemplary mobile communications system according with the present invention.

FIG. 1a is a block diagram of a mobile communications device when configured in accordance with one embodiment of the invention.

FIG. 1b is a block diagram of a base station when configured in accordance with one embodiment of the invention.

FIG. 2 is a block diagram of a transmit chain when configured in accordance with one embodiment of the invention.

FIG. 2a is a block of the placement of the transmit symbols in the OFDM block in accordance with one embodiment of the invention.

FIG. 2b is set of graphs illustrating communication channel performance of one embodiment of the invention.

FIG. 2c is a block diagram of the receive chain when configured in accordance with one embodiment of the invention.

FIG. 2d is a block diagram of one exemplary embodiment of an iterative demodulation and decoding apparatus and methodology according to the present invention.

FIG. 3 is a block diagram of the transmit chain when configured in accordance with another embodiment of the invention.

FIG. 3a is a block diagram of a receive chain when configured in accordance with another embodiment of the invention.

FIG. 4 is a block diagram of a transmit chain configured in accordance with still another embodiment of the invention.

FIG. 5 is a set of graphs illustrating the channel performance of one embodiment of the invention (i.e., diversity code with and without EST, symbol shuffling, and MFB).

FIG. 6 is a set of graphs illustrating the channel performance of one embodiment of the invention (four transmit antennas and various EST configurations).

FIG. 7 is a set of graphs illustrating the channel performance of one embodiment of the invention (various numbers of transmit antennas).

### DETAILED DESCRIPTION OF THE INVENTION

Reference is now made to the drawings wherein like numerals refer to like parts throughout.

As used herein, the terms “subscriber unit,” “client mobile device” and “CMD” include, but are not limited to, personal digital assistants (PDAs), handheld computers, personal communicators, J2ME equipped devices, cellular telephones, “SIP” phones, personal computers (PCs) and minicomputers, whether desktop, laptop, or otherwise, or literally any other device capable of receiving video, audio or data over a network.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, TCP/IP, H.323, etc.).

As used herein, the term “network agent” refers to any network entity (whether software, firmware, and/or hardware based) adapted to perform one or more specific purposes. For example, a network agent may comprise a computer program running in a server belonging to a network operator, which is in communication with one or more processes on a client device or other device.

As used herein, the term “application” refers generally to a unit of executable software that implements a certain functionality or theme. The themes of applications vary broadly across any number of disciplines and functions (such as communications, instant messaging, content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the Java™ environment.

As used herein, the terms “computer program”, “code” or “software” are meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

Additionally, the terms “selection” and “input” refer generally to user or other input using a keypad or other input device as is well known in the art.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the term “display” means any type of device adapted to display information, including without limitation CRTs, LCDs, TFTs, plasma displays, LEDs, and fluorescent devices.

As used herein, the term “cellular” includes any form of cell-based mobile communications system including cellular telephones, “walkie-talkie” devices (such as those marketed by Nextel and Motorola Corporations, and so-called PTx (“push-to-anything”) devices such as the exemplary PTT (push-to-talk over cellular) devices which establish and tear down SIP or other communications sessions as part of their protocol.

As used herein, the term “speech recognition” refers to any methodology or technique by which human or other speech can be interpreted and converted to an electronic or data format or signals related thereto. It will be recognized that any number of different forms of spectral analysis such as, without limitation, MFCC (Mel Frequency Cepstral Coefficients) or cochlea modeling, may be used. Phoneme/word recognition, if used, may be based on HMM (hidden Markov modeling), although other processes such as, without limitation, DTW (Dynamic Time Warping) or NNs (Neural Networks) may be used. Myriad speech recognition systems and algorithms are available, all considered within the scope of the invention disclosed herein.

As used herein, the term “user interface” refers to, without limitation, any visual, graphical, tactile, audible, sensory, or other means of providing information to and/or receiving information from a user or other entity.

As used herein, the term “Wi-Fi” refers to, without limitation, any of the variants of IEEE-Std. 802.11 or related standards including 802.11 a/b/g/n.

As used herein, the term “wireless” means any wireless signal, data, communication, or other interface including without limitation Wi-Fi, Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

### Overview

In one exemplary aspect, the present invention comprises methods and associated apparatus for conducting wireless communication using multi-carrier code division multiple access modulation with energy spreading.

In one variant of the invention, an energy-spreading technique (EST) is applied within a code-divided system (e.g., multi-carrier or MC-CDMA) to improve signal detection performance and diversity. Significant improvements in Eb/N0 are achieved for both indoor and urban paradigms as compared to a comparable system (e.g., MC-CDMA) without such EST capability.

In another variant, a code-divided system with two transmit antennas is disclosed. In this system, a diversity code (such as for example the well known Alamouti code) is used to obtain enhanced transmit diversity. Another variant incorporates a “symbol shuffling” scheme (together with the aforementioned EST) to enhance diversity and performance. The symbol shuffling scheme and diversity code (e.g., Alamouti code) may also be combined to provide a matched filter bound (MFB) for systems with four or more antennas.

Exemplary base station and subscriber (e.g., mobile) unit configurations are also disclosed, as well as system architectures implementing the foregoing improvements.

### Detailed Description of Exemplary Embodiments

Exemplary embodiments of the apparatus and methods of the present invention are now described in detail. While various functions are ascribed herein to various systems and components located throughout a network, it should be understood that the configuration shown is only one embodiment of the invention, and performing the same or similar functions at other nodes or locations in the network may be utilized consistent with other embodiments of the invention.

Also, the various systems that comprise aspects of the invention are typically implemented using software running on semiconductor microprocessors or other computer systems, the use of which is well known in the art. Similarly, the various process described herein may also be performed by software running on a microprocessor, although other implementations including firmware, hardware, and even human performed steps, are also consistent with the invention.

It will further be appreciated that while certain aspects and embodiments are described generally in the context of a network providing service to a customer or consumer end user domain, the present invention may be readily adapted to other types of environments including, e.g., enterprise (e.g., corporate), public service (non-profit), and government/military applications. Myriad other applications are possible.

Lastly, while described primarily in the context of a mobile subscriber network (e.g., cellular telephones), the invention is in no way limited to such platforms, and may be used with equal success on other wireless or wire-line devices, fixed platforms, satellite systems, millimeter wave systems, and the like. For example, the techniques of the present invention are equally useful within a “WiFi” or other wireless LAN or WAN configuration.

### Mobile Communications Devices and Network

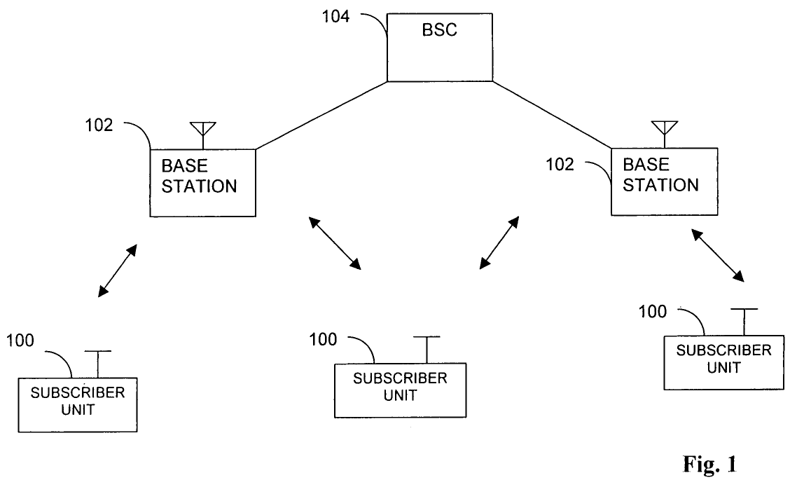

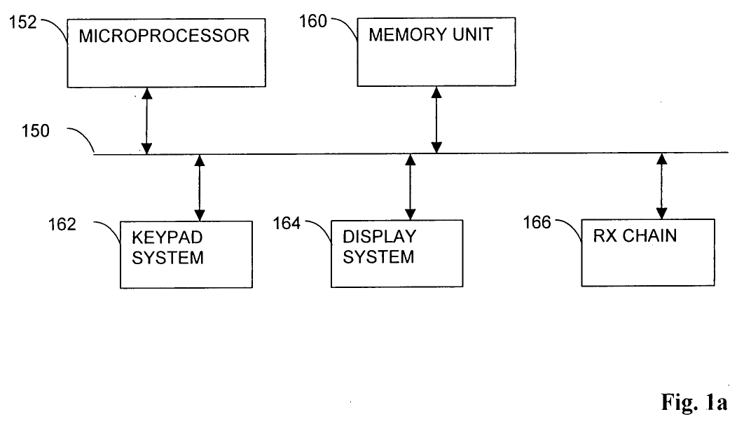

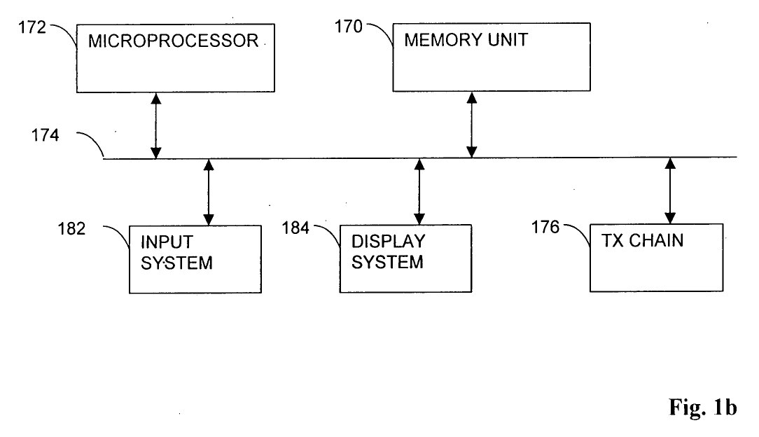

FIG. 1 is a simplified block diagram of a mobile communications network configured in accordance with one embodiment of the invention. Subscriber units 100 are typically cell phones or other mobile communication devices (e.g., client mobile devices) that interface with base stations 102. Communication is conducted via the exchange of RF signals between the subscriber units 100 and base stations 102. The base stations 102 are connected and controlled via base station controller (BSC) 104.

In the exemplary embodiment a set of one or more subscriber unit 100 each transmit and RF signals to one or more base stations 102. The transmission from a subscriber unit 100 to a base station is commonly referred to as the “reverse link.” Additionally, each base station 102 transmits an RF signal to a set of one or more subscriber units 100. The transmission from the base station 102 to one or more subscriber units is commonly referred to as the “forward link.” It will be recognized, however, that the terms “reverse” and “forward” are merely relative, and in no way restrictive on the invention or functions associated therewith.

Since the reverse link typically carries the information associated with a single subscriber unit, it is typically called a “single user” signal. That is, the reverse link transmission carries information from a single user. In many instances, however, the reverse link may contain different channels used for different functions such as data, voice, multimedia, control and other information.

The forward link transmission is typically from a single source (base station 102) to multiple subscriber units 100. Therefore the forward link typically contains multiple user channels each of which are directed to a different subscriber unit 100, although an individual subscriber unit may process multiple channels in some cases. Therefore, the forward link channel is often referred to as a “multi-user” channel.

In an exemplary embodiment of the invention, the forward links from different bases stations are transmitted using the same frequency “band” or “range”. This is sometimes referred to as frequency reuse. The different forward link channels from different base stations are distinguished by the use of different “codes” or code offsets (or other differentiating techniques) at each base station to modulate the signal in accordance with CDMA signal processing techniques, although it will be appreciated that other approaches may be used.

Similarly, the reverse link transmission from different subscriber units 100 are in the illustrated embodiment transmitted over the same RF band. The different transmission from different subscriber units 100 are distinguished via the use of different codes, code offsets, or the like.

By transmitting the forward and reverse links in the same frequency band the network can use a “soft hand-off” process as a subscriber unit moves from the coverage area of one base station 100. For example, a subscriber unit 100 can receive forward links from two different base stations 102, and process and combine them to extract the user channel associated with the current communication. Similarly, two bases stations 102 can receive and process the same reverse link from a particular subscriber unit 100. The base station can then forward the extracted data to base station controller (BSC) 104 where it is combined or selected for further forwarding to the network.

FIG. 1a is a block diagram of an exemplary subscriber unit when configured in accordance with one embodiment of the invention. A microprocessor 152 is coupled to memory unit 160 via a data bus 150. Additionally, a receive (Rx) chain 166 is in data communication with the bus 150, as are input system 162 and display system 164. It will be appreciated that while a unified bus architecture is shown for sake of simplicity, any number of different architectures and techniques known to those of ordinary skill in the electronic device arts may be used with equal success. For example, a multi-bus structure may be used, or even radio frequency, IR, or optical data linking between components employed.

During operation, software stored in memory unit 160 is run by the microprocessor 152. The microprocessor 152 in turn interfaces with and controls the various other systems including the input system 162, display system 164 and Rx chain 166. The input system may be a keypad, wheel, mouse, stick, touch-screen, speech recognition system, or other input system well known in the art. The display system comprises an LCD display with associated driver of the type ubiquitous in electronic devices, although other display technologies may be used with equal success.

Various software applications may also be run on the subscriber device, including those for call or contact management, data transfer or sessions (e.g., WAP 2.0 stack), and so forth.

The Rx chain 166 typically incorporates the use of an antenna system, downconverter, digitizer and baseband processor of the type well known in the art, although other non-heterodyned or carrier-less architectures (e.g., UWB, direct conversion, etc.) may also be employed. In the illustrated embodiment, RF signals are received via the antenna and downconverted from RF to baseband. The baseband signals are then digitized by the analog to digital converter and the resulting digital samples are processed by the baseband processor. The baseband processor is typically one or more semiconductor integrated circuits, programmable digital signal processors (DSP) or field programmable gate arrays (FPGA).

In some embodiments of the invention, multiple antenna systems (or multi-component antennas) are used. In one such embodiment, two antennas and down converters are employed. Additionally, multiple A/D converters may also be used.

FIG. 1b is a block diagram of a base station 102 when configured in accordance with one embodiment of the invention. A microprocessor 172 is coupled to a memory unit 170 via the bus 174. Additionally, the transmit (Tx) chain 176 is coupled to the bus 174, as are the input system 182 and display system 184. As with the subscriber device of FIG. 1a, myriad other bus, component, and functional configurations may be used consistent with the invention.

During operation, software stored in the memory unit 170 is run by the microprocessor 172. The microprocessor 172 in turn interfaces with and controls the various other systems including the input system 182, display system 184 and Tx chain 176. As with the subscriber unit of FIG. 1a, the input and display systems 182, 184 may comprise any number of different configurations that will be immediately recognized by those of ordinary skill provided the present disclosure.

The Tx chain 176 typically incorporates the use of an antenna system, upconverter, digitizer and baseband processor. As with the Rx chain, however, other types of conversion/transmission processes may be employed, however, such as UWB or direct conversion. In the illustrated embodiment, data to be transmitted is modulated and converted from digital to analog, upconverted and then transmitted from the antenna. The baseband processor is typically one or more semiconductor integrated circuits, programmable digital signal processors (DSP) or field programmable gate arrays (FPGA). In some embodiments of the invention multiple antenna systems are used. In this case, two antennas and upconverters are typically employed. Additionally, multiple D/A converters may also be employed.

It will be appreciated that the devices of FIGS. 1a and/or 1b may also be multi-functional; e.g., wherein each employs both Rx and Tx chains. Such devices may also accommodate more than one air interface; e.g., 3G, IS-95, GSM, etc.

### Energy-Spread Variants

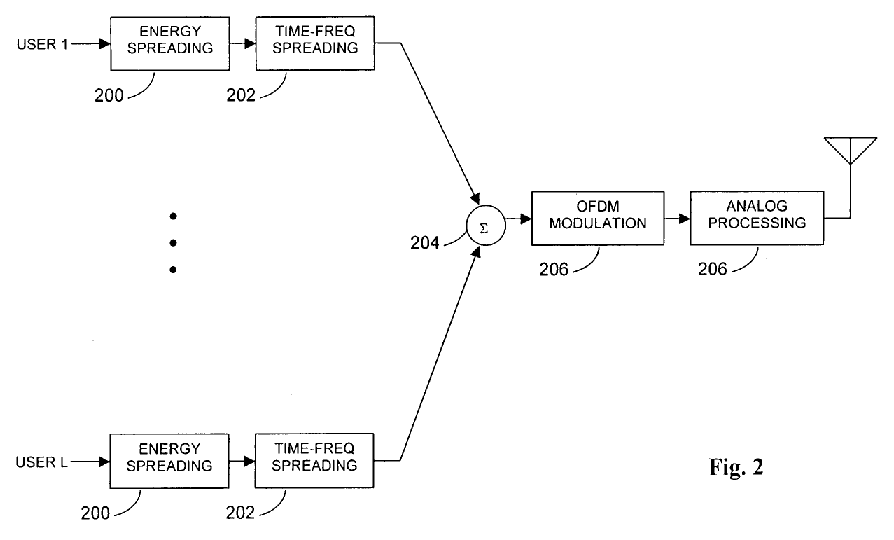

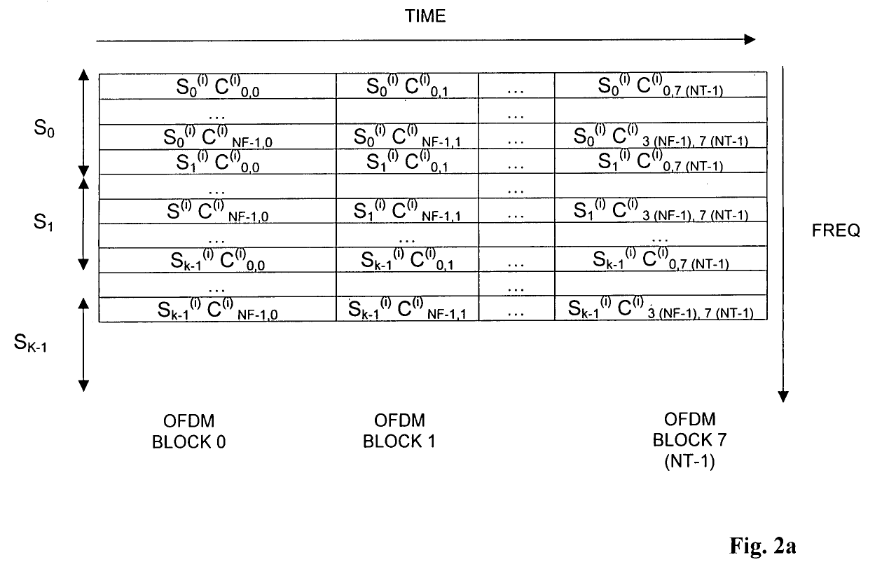

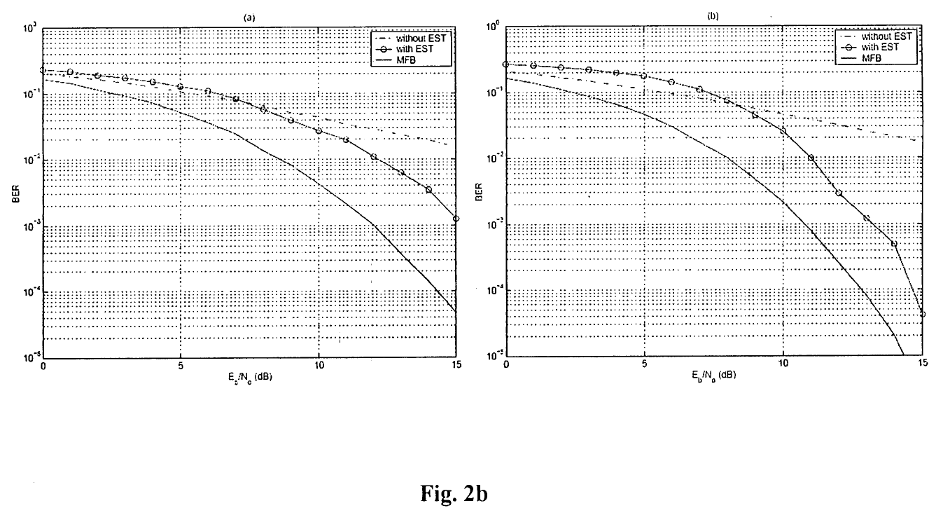

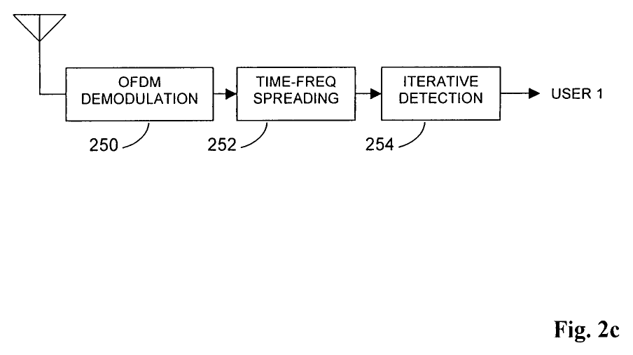

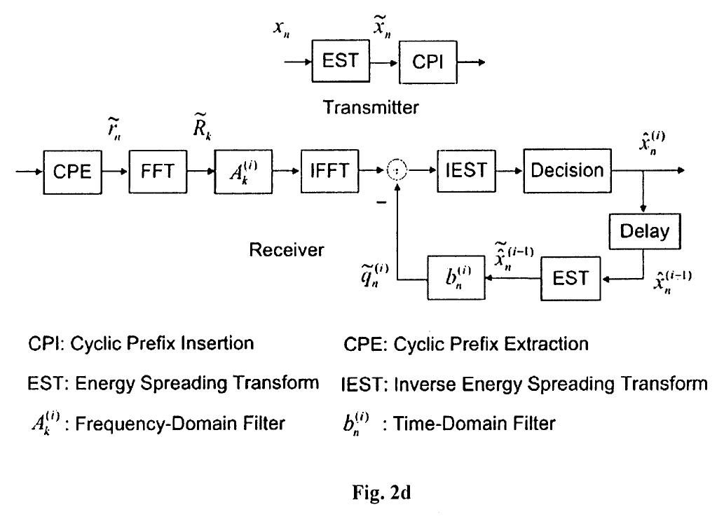

FIG. 2 is a block diagram of the baseband processing performed at the Tx chain in accordance with one embodiment of the invention which makes use of the aforementioned energy spreading techniques (EST). The illustrated functional blocks may represent steps or functions performed in a method or process, or the blocks may represent portions of a circuit.

The different user data streams (USER1-USER L) are received by corresponding energy spreading blocks 200. In one embodiment of the invention, the energy spreading involves multiplication by an L×L matrix to yield L energy spread symbols. That is, the energy spread samples for L users are generated by the following exemplary operation:

s⁽ⁱ⁾=Eb⁽ⁱ⁾ (1)

Where s⁽ⁱ⁾ comprises a set of L energy spread symbols, E comprises the L×L energy spreading matrix, and b⁽ⁱ⁾ comprises a set of L information bits from the L users streams. Specifically:

$${s}^{( i )} = ( \begin{matrix}{s}_{0}^{( i )} \\ {s}_{1}^{( i )} \\ ⋮ \\ {s}_{K - 1}^{( i )}\end{matrix} ) and {b}^{( i )} = ( \begin{matrix}{b}_{0}^{( i )} \\ {b}_{1}^{( i )} \\ ⋮ \\ {b}_{K - 1}^{( i )}\end{matrix} ) \qquad ( 2 )$$

In one embodiment of the invention, the energy-spreading matrix is formed by the multiplication of two unitary matrices with two random permutation matrices for two different random interleavers. It will be recognized by those of ordinary skill that such unitary matrices may comprise any number of different types, including for example and without limitation Hadamard or Fourier transform matrices, or other types of unitary transforms. In particular, E is formed by the following equation:

E=P₂T P₁T (3)

where T is a Hadamard transform matrix of size N×N scale by the factor 1/N^{0.5}, and P₂ and P₁ are random permutation matrices for random interleavers. Exemplary processes for generating spreading matrixes is described in T. Hwang and Y. (G) Li, “A bandwidth efficient block transmission with frequency-domain equalization,” in Proc. Ieee 6^{th} Symp. Emerging Technologies, vol. 2, 204, pp. 433-436, which is incorporated herein by reference in its entirety. Additional discussion on the use of energy spreading transforms can be found in T. Hwang and Y. (G) Li, “Novel iterative equalization based on energy spreading transform,” Proc. of 2004 IEEE International Conf. on commun., Paris, France, June 2004 /IEEE Trans. Signal Processing, vol 54, no. 1, pp. 190-203, January 2006, also incorporated herein by reference in its entirety. See also Appendix I hereto, which provides additional details in this regard with respect to one exemplary implementation.

The energy spread symbols s⁽ⁱ⁾ comprise the time-frequency spread generated by the time-frequency spreading circuits 202 of FIG. 2. This spreading is preferably performed using a set of orthogonal spreading codes, which are typically a set of Walsh codes, the generation and use of which are well known in the art. In the exemplary embodiments, the set of Walsh codes are each eight bits or “chips” in length. This creates a Walsh code space of eight Walsh codes. Each set of user data is modulated with four Walsh codes from this eight Walsh code space. This results in a set of thirty-two (32) chips of “spread” data for each user channel.

The spread data is then combined via a summation process 204 and the resulting combined signal is placed into frequency orthogonal carriers via orthogonal frequency division modulator 206. The output of the OFDM modulator 206 is then processed by an analog processing system 206 where it is converted from digital to analog, upconverted and transmitted via the antenna system. As previously discussed, the invention is substantially agnostic or independent of the analog processing or conversion used.

In accordance with one embodiment of the invention, the spread data is placed in a set of N_{T} OFDM blocks (or OFDM symbols) and N_{F} carriers within those OFDM blocks. In particular, the eight chips of spread data from each Walsh code are placed in the same carrier bin of N_{T} (N_{T}=8) OFDM blocks. Additionally, the four Walsh codes used to modulate a particular data bit are placed in four different carrier bins of the OFDM block.

FIG. 2a is a diagram illustrating the placement of the spread data into the OFDM blocks in accordance with one exemplary embodiment of the invention. The chips associated with the energy spread symbol S₀ and the first Walsh code C⁽ⁱ⁾₀ are placed into the first frequency bin of the first _{T} OFDM blocks. The chips associated with the energy spread symbol S₀ (from the first USER) and Walsh codes C⁽ⁱ⁾₁ through C⁽ⁱ⁾_{NT-1} (where NT=4 in the exemplary embodiment) are placed in subsequent carriers of the same eight OFDM blocks.

Similarly, the chips associated with the energy spread symbol S₁ (from the second USER) and the first Walsh code C⁽ⁱ⁾₀ are placed into the next available frequency bin of the first N_{T} OFDM blocks. The chips associated with the energy spread symbol S₁ and Walsh codes C⁽ⁱ⁾₁ through C⁽ⁱ⁾_{NT-1} (where NT=4 in the exemplary embodiment) are placed in subsequent carriers of the same eight OFDM blocks.

Finally, the chips associated with the energy spread symbol Sk-₁ (k-₁=31 in the exemplary embodiment ) and the first Walsh code C⁽ⁱ⁾₀ are placed into the next available frequency bin of the first N_{T} OFDM blocks. The chips associated with the energy spread symbol Sₖ₋₁ and Walsh codes C⁽ⁱ⁾₁ through C⁽ⁱ⁾_{NT-1} (where NT=4 in the exemplary embodiment) are placed in subsequent carriers of the same eight OFDM blocks.

In an exemplary embodiment, the sub-carrier space (bandwidth) is 56.34 kHz, although this value may be varied as necessary for particular applications. From the orthogonal condition, the length of the OFDM symbol is Tₓ=17.75 usec. If a cyclic extension of length Tg=3.75 usec is used, then the overall symbol length will be 21.5 usec. There are 736 sub-carriers in the OFDM block used in the exemplary embodiment of the invention. This places the overall bandwidth at 41.46 MHz.

With each transmitted symbol spread over NF=4 adjacent sub-carriers and NT=8 adjacent OFDM blocks, the user can transmit 184 QPSK symbols within 8 OFDM blocks. This corresponds to a data transmission rate of 2.14 Mbits/sec. The exemplary multi-carrier CDMA (MC-CDMA) system can hold up to 32 synchronized users without multi-user or mutual interference (MUI). In an exemplary processing, four iterations are used in signal detection, although this value may be increased or decreased.

FIG. 2b shows a set of graphs illustrating the advantages of conducting communication using the system described in the exemplary embodiment of the invention. These graphs compare the performance of the exemplary embodiment described above with and without the use of energy spreading (EST) in the processing. The performance is compared using the BRAN-A indoor channel {graph (a)} and the BRAN-E urban channel {graph (b)}. From these graphs, it is noted that the required E_{b}/N₀'s for a 10⁻² bit-error-rate (BER) are improved by 5 dB for both the indoor channel and the urban channel.

FIG. 2c is a block diagram of a receive (Rx) system when configured in accordance with one embodiment of the invention. The antenna and associated analog system(s) receive the signals, perform down-conversion (e.g., via an IF) and digitization of the analog signals. OFDM demodulation circuits 250 perform OFDM demodulation. The data from OFDM demodulation circuit is then de-spread by time-frequency despreading circuit 252, and the iterative detection circuit 254 repeatedly decodes the data to generate the hard decision output stream. Typically, four iterative decoding and demodulating steps are sufficient to provide a reasonable trade off between performance and complexity. Exemplary iterative decoding and demodulating techniques are described in T. Hwang and Y. (G) Li, “Novel iterative equalization based on energy spreading transform,” Proc. of 2004 IEEE International Conf on commun., previously incorporated herein by reference in its entirety, although it will be appreciated that other approaches may be substituted with success. See also FIG. 2d herein, which illustrates such an exemplary iterative demodulation and decoding apparatus and process.

### Space-Time Coded Variants

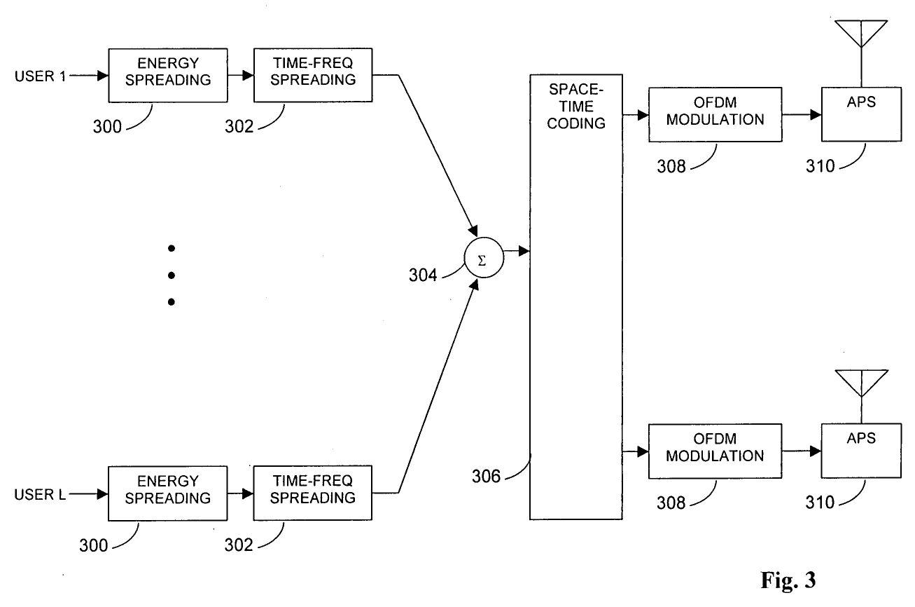

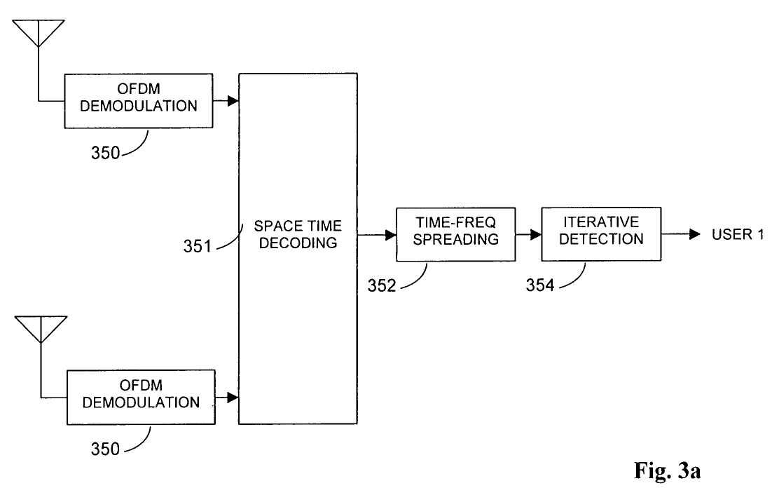

FIG. 3 is a block diagram of exemplary transmit processing performed in accordance with another embodiment of the invention. This transmit processing is typically performed at the base station where a transmission directed at multiple subscriber units is generated, although such processing may be performed at other locations, such as e.g., at a centralized transmission facility, network agent or node, or even within another mobile subscriber unit or device. It will be appreciated that the blocks or functions shown in FIG. 3 can represent actual circuits, method or process steps, or some combination thereof.

The different user data streams (USER1-USER L) are received by the energy spreading blocks 300. In one embodiment of the invention, the energy spreading involves multiplication by a L×L matrix to yield L energy spread symbols. That is, the energy spread samples for L users are generated by the use of equation (1) listed above. In an exemplary configuration, the energy spreading matrix for a value of L=32 is as specified above with reference to FIG. 2. See also Appendix I hereto, which provides additional details in this regard with respect to one exemplary implementation.

The illustrated energy spreading matrix is formed by the multiplication of two Hadamard transform matrix with two random permutation matrices for two different random interleavers. In particular E is formed by the use of equation (3) listed above.

The energy spread symbols comprise the time-frequency spread by time-frequency spreading circuits 202. This spreading is preferably performed using a set of orthogonal spreading codes, which are typically a set of Walsh codes, the use of which is well known in the art. In the exemplary embodiments a set of Walsh codes are used, each Walsh code being eight bits or “chips” in length. This creates a Walsh code space of eight Walsh codes. In one embodiment of the invention, each set of user data is modulated with four Walsh codes from this eight Walsh code space. This results in a set of thirty-two (32) chips of “spread” data for each user channel. It will be recognized, however, that other code configurations and spaces may be used consistent with the invention.

The spread data is then combined, such as via the illustrated summation logic 304. The resulting combined signal is then space-time coded by a space-time coding circuit 306. The multiple output streams from space-time coding circuit 306 are then individually OFDM modulated via two orthogonal frequency division modulators 308. The outputs of OFDM modulators 308 are then processed by respective analog processing systems 310 where they are converted from digital to analog, upconverted and transmitted via the individual antenna systems. The antennas preferably configured to have different directional properties, although this is by no means a requirement for practicing the invention.

It will be appreciated that while two outputs and transmission channels for the space-time coding circuit 306 are shown, other numbers may be used consistent with the invention.

In accordance with one embodiment of the invention, the space-time coded data is placed in a set of N_{T} OFDM blocks (or OFDM symbols) as described above with reference to FIG. 2a.

In accordance with one variant, the space-time coding is performed via the use of a diversity code such as, e.g. Alamouti's code, although it will be recognized that other space-time or diversity codes may be used.

As is known to those of ordinary skill, Alamouti's code is a transmit diversity scheme comprising a space-time block code with support for multiple (two) transmit antennas and an arbitrary number of receive antennas. In this case, the transmitted signal (x_{1,n})can be expressed as:

$$( \begin{matrix}{x}_{l , 2 n}^{( 1 )} & {x}_{l , 2 n + 1}^{( 1 )} \\ {x}_{l , 2 n}^{( 2 )} & {x}_{l , 2 n + 1}^{( 2 )}\end{matrix} ) = \frac{1}{\sqrt{2}} ( \begin{matrix}{u}_{l , 2 n} & {u}_{l , 2 n + 1}^{*} \\ {u}_{l , 2 n + 1} & - {u}_{l , 2 n}^{*}\end{matrix} ) . \qquad ( 5 )$$

where u_{1,n} is the output of combiner circuit 306.

In accordance with another embodiment of the invention, a symbol shuffling scheme is employed by the space-time coding circuit 306. Symbol shuffling is particularly useful when an arbitrary number of transmit antennas are employed (M_{T}) that is not equal to two (2). In the case of such symbol shuffling, the energy spread symbols are first divided into M_{T} subsets using Eqn. (4):

Sₚ={sₖ: k=p mod M_{T}} (4)

for p=0, . . . , K/M_{T}−1.

The different subsets Sₚ are then transmitted through different antenna systems. Since each symbol occupies NF sub-carriers or tones in an OFDM block, the transmitted signals from the p-th antenna will be U_{1,n} (the output of summation circuit if I/N_{F}=ₚ mod M_{T}, and 0 otherwise). In other words, only certain carriers of the OFDM symbol will contain information depending on the particular antenna system from which the symbol is being transmitted.

FIG. 3a is a block diagram of an exemplary receiver system when configured in accordance with one embodiment of the invention. The illustrated antenna systems and their associated analog processing circuits (not shown) receive the signals, and perform downconversion and digitization of the analog signals. OFDM demodulation circuits 350 perform OFDM demodulation, and space-time decoding circuit 351 performs space-time decoding on the demodulated data from OFDM demodulators 350 including combining the data from the different received transmissions.

The combined data from the space-time decoding circuit is despread by time-frequency despreading circuit 352, and the iterative detection circuit 354 repeatedly decodes the data to generate the hard decision output stream. Typically, four iterative decoding and demodulating steps are sufficient to provide a reasonable trade off between performance and complexity, although it will be appreciated that other numbers of steps may be used consistent with the invention, based on the particular performance attributes desired.

Exemplary iterative decoding and demodulating techniques are described in T. Hwang and Y. (G) Li, “Novel iterative equalization based on energy spreading transform,” Proc. of 2004 IEEE International Conf on commun., previously incorporated herein by reference in its entirety, although it will be appreciated that other approaches may be substituted with success. See also FIG. 2d previously discussed herein, which illustrates such an exemplary iterative demodulation and decoding apparatus and process.

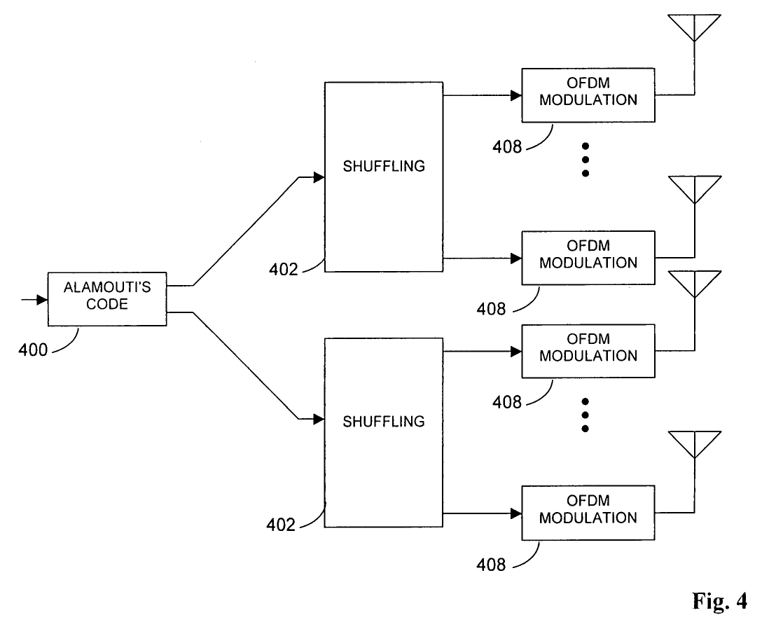

FIG. 4 is a block diagram of a transmit scheme configured in accordance with yet another embodiment of the invention. In this embodiment, the advantages of Alamouti's code are combined with shuffling to allow for the use of more than two antennas.

The time frequency spread signals are processed using Alamouti's code in block 400. The two resulting data streams are then passed through shuffling circuits 402. Shuffling circuits may be configured to generate any number of additional data streams, which are further modulated by OFDM modulators 404. The resulting modulated data is then transmitted via the antenna systems.

As can be appreciated, the architecture of FIG. 4 is scalable, both in terms of the overall system (i.e., multiple Alamouti code blocks 400 and associated shuffling units can be used), as well as individual components of the system (e.g., OFDM modulators 408, etc.).

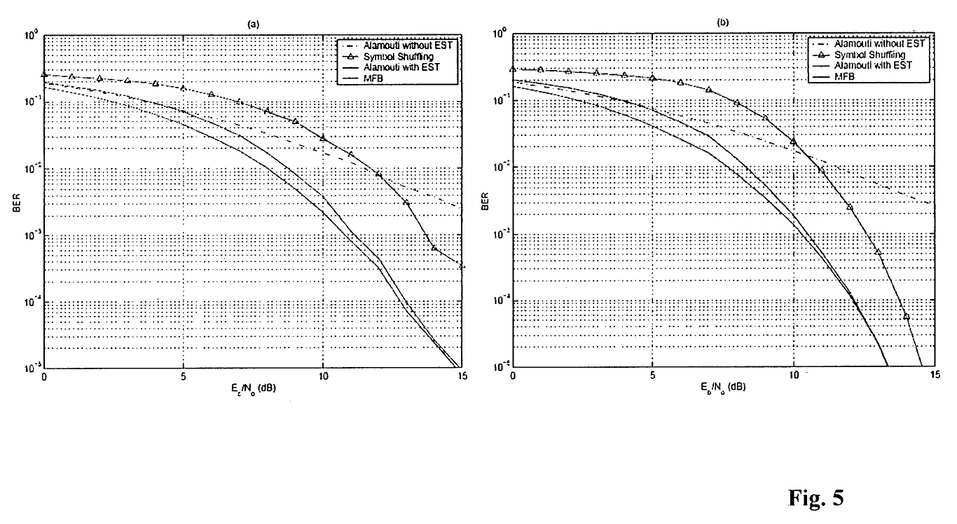

FIG. 5 shows a set of graphs illustrating -the performance of the communication system when configured in accordance with one embodiment of the invention. Both graphs show the performance of the exemplary multi-carrier (MC) CDMA system in various configurations. These configurations include Alamouti processing alone (without energy spreading or EST), symbol shuffling (with EST), and Alamouti processing and EST. Additionally, a plot for the matched filter bound (MFB) is included. In the present context, MFB represents the performance limit of signal detection for frequency selective channels, used in this exemplary embodiment as a reference.

Graph (a) shows the performance of an exemplary indoor (BRAN-A) channel. As can been seen, the graph shows the Alamouti processing with EST having the best performance, followed by either the symbol shuffling or the Alamouti without EST, depending on the selected performance point (e.g., BER). At a performance point of 10E-2 bit error rate (BER), the performance gain may be as high as 3 dB for this embodiment.

Graph (b) illustrates the performance of an exemplary outdoor (BRAN-E) channel. The same configurations are plotted as that of graph (a). Once again, the best performance is achieved by the combination of Alamouti with EST. Improvement on the order of 3 dB is also achieved at the performance point of 10E-2 BER.

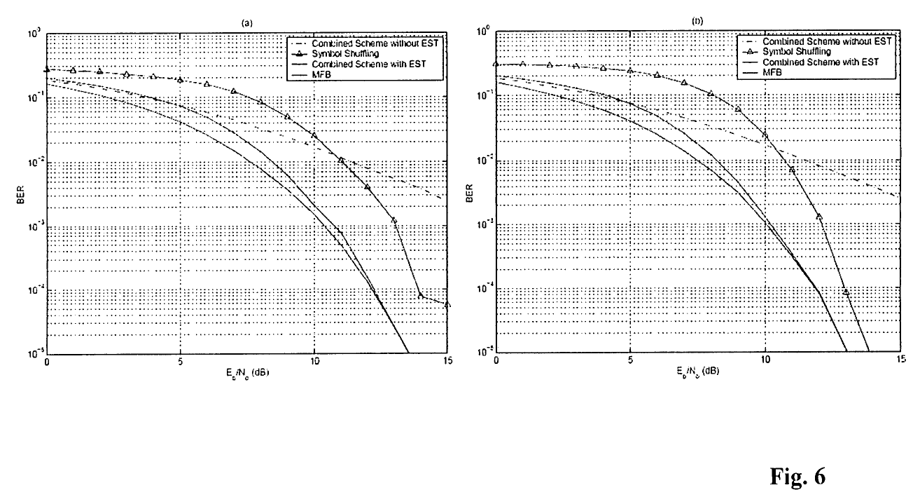

FIG. 6 shows another set of graphs illustrating the performance of an exemplary EST-configured communication system when configured in accordance with one embodiment of the invention. The plots in FIG. 6 correspond to the use of four transmit antenna systems configured as shown in FIG. 4 herein. Graph (a) is for the indoor channel and graph (b) is for the urban channel. Similar performance gains as those shown in FIG. 5 are achieved, with the combined scheme achieving substantial performance improvements over simple symbol shuffling or the combined scheme without EST.

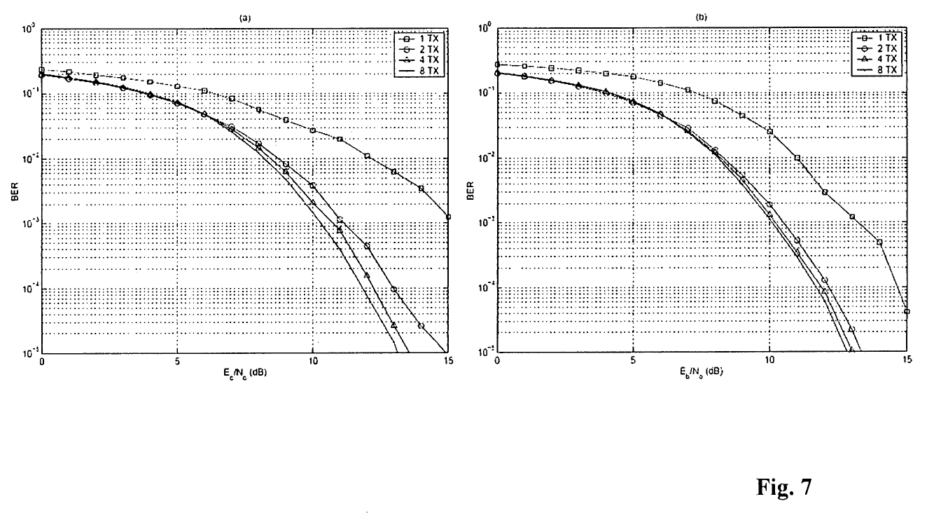

FIG. 7 shows yet another set of graphs illustrating the performance of the communication system when configured in accordance with another embodiment of the invention. Specifically, FIG. 7 compares the performance of MC-CDMA systems with different numbers of transmit antennas.

Graph (a) is for the indoor channel and graph (b) is for the outdoor channel. As indicated in FIG. 7, the performance improvement with the increase of the number of transmit antennas is somewhat limited for an urban channel with low E_{b}/N₀. However, the performance improves significantly with the number of transmit antennas when the E_{b}/N₀ is larger, e.g., for an indoor channel It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

Many other permutations of the foregoing system components and methods may also be used consistent with the present invention, as will be recognized by those of ordinary skill in the field.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method for communicating in a wireless network, said wireless network including a base station and at least one subscriber unit, said base station transmitting at least one data stream to said at least subscriber unit, said method comprising:
energy spreading said at least one data stream to generate at least one energy spread data stream;
time-frequency spreading said at least one energy spread data stream using a plurality of orthogonal spreading codes to generate at least one spread spectrum data stream; and
placing said at least one spread spectrum data stream into a plurality of frequency orthogonal carriers to generate at least one orthogonal frequency division access signal.

2. The method as set forth in claim 1, further comprising:
receiving said orthogonal frequency division access signal;
performing demodulation on said orthogonal frequency division access signal to generate at least one demodulated spread sample;
despreading said demodulated spread sample to generate at least one symbol sample; and
iteratively detecting at least one signal associated with a particular user in said at least one symbol samples.

3. The method as set forth in claim 2, wherein said step of iteratively detecting comprises:
applying an inverse energy spreading transform to produce first data;
directly or indirectly applying a decision process to said first data to produce second data;
applying a delay to produce delayed data;
applying an energy spreading transform to said delayed data to produce transformed data; and
applying a filtration process to said transformed data.

4. The method as set forth in claim 2, further comprising combining said transformed data with said symbol sample.

5. The method as set forth in claim 1, wherein said step of energy spreading comprises energy spreading according to:
s⁽ⁱ⁾=Eb⁽ⁱ⁾
where s⁽ⁱ⁾ comprises a set of L energy spread symbols, E comprises an L×L energy spreading matrix, and b⁽ⁱ⁾ comprises a set of L information bits from L user streams.

6. The method as set forth in claim 1, further comprising performing space-time coding on said at least one spread spectrum data stream.

7. The method as set forth in claim 6, further comprising performing space-time decoding on said at least one spread sample.

8. The method as set forth in claim 6, wherein said performing space time coding is performed using an Alamouti diversity code

9. A method for operating a subscriber unit for receiving an energy spread multi-carrier code division multiple access signal, said method comprising:
receiving said orthogonal frequency division access signal;
performing OFDM demodulation on said orthogonal frequency division access signal to generate demodulated spread samples;
despreading said demodulated spread samples to generate symbol samples; and
iteratively detecting user signals in said set of symbol samples.

10. The method as set forth in claim 9, wherein said step of iteratively detecting comprises:
applying an inverse energy spreading transform;
thereafter applying a decision process;
applying a delay to produce delayed data;
applying an energy spreading transform to said delayed data to produce transformed data; and
applying a filtration process to said transformed data.

11. The method as set forth in claim 9, further comprising performing space-time decoding on said spread samples.

12. The method as set forth in claim 11, wherein said space-time decoding comprises recovering different subsets of data that have been transmitted through different antenna systems.

13. A method for operating a base station transmitting a set of data streams to a set of users, said method comprising:
energy spreading each data stream from said set of data streams to generate a set of energy spread data streams;
time-frequency spreading said set of energy spread data streams using a set of orthogonal spreading codes to generate a set of spread spectrum data streams; and
placing said set of spread spectrum data streams into a set of frequency orthogonal carriers to generate an orthogonal frequency division access signal.

14. A subscriber unit for receiving an energy spread multi-carrier code division multiple access signal, said subscriber unit comprising:
radio frequency downconversion apparatus for converting a received radio frequency signal to a baseband signal;
analog-to-digital conversion apparatus for converting said baseband signal to digital samples;
Fourier transform apparatus for performing OFDM demodulation on said digital samples to generate demodulated spread samples;
correlation apparatus for despreading said demodulated spread samples to generate symbol samples; and
demodulation apparatus configured to iteratively detect user signals in said set of symbol samples.

15. The subscriber unit as set forth in claim 14, further comprising:
first antenna apparatus for receiving a first RF signal;
second antenna apparatus for receiving a second RF signal; and
space-time decoding apparatus for processing said first RF signal and said second RF signal.

16. The subscriber unit as set forth in claim 15 wherein said space-time decoding apparatus is configured to recover different subsets of data that have been received by said first and second antenna apparatus.

17. A base station for transmitting a plurality of data streams to a plurality of users, said base station comprising:
a Hadamard transform apparatus configured to energy-spread each data stream from said plurality of data streams to generate a plurality of energy spread data streams;
modulation circuitry for time-frequency spreading said plurality of energy spread data streams using a set of orthogonal spreading codes to generate a plurality of spread spectrum data streams; and
inverse Fourier transform circuitry for placing said set of spread spectrum data streams into a plurality of frequency orthogonal carriers to generate an orthogonal frequency division access signal.

18. The base station as set forth in claim 17, further comprising digital to analog conversion circuitry for converting said orthogonal frequency division access signal to a baseband signal.

19. Wireless network apparatus adapted to transmit a set of data streams to a set of user devices, said apparatus comprising:
apparatus configured to energy spread each data stream from said set of data streams to generate a set of energy spread data streams;
apparatus configured to time-frequency spread said set of energy spread data streams using a set of orthogonal spreading codes to generate a set of spread spectrum data streams; and
apparatus configured to place said set of spread spectrum data streams into a set of frequency orthogonal carriers to generate an orthogonal frequency division access signal.

20. A wireless communication system comprising:
at least one transmitter comprising:
apparatus configured to energy spread each data stream from said set of data streams to generate a set of energy spread data streams;
apparatus configured to time-frequency spread said set of energy spread data streams using a set of orthogonal spreading codes to generate a set of spread spectrum data streams; and
apparatus configured to place said set of spread spectrum data streams into a set of frequency orthogonal carriers to generate an orthogonal frequency division access signal; and
a plurality of receivers, each of said receivers being configured to:
receive said orthogonal frequency division access signal;
perform OFDM demodulation on said orthogonal frequency division access signal to generate demodulated spread samples;
despread said demodulated spread samples to generate symbol samples; and
iteratively detect user signals in said set of symbol samples.

21. The system of claim 20, wherein said system comprises a multi-carrier CDMA (MC-CDMA) system.

22. The system of claim 20, wherein said at least one transmitter comprises one of a plurality of cellular base stations within said system, and at least a portion of said plurality of receivers comprise mobile units.

23. A computer-readable storage medium adapted to store data comprising a computer program, said computer program being configured to, during operation:
receive a multi-carrier orthogonal frequency division access signal;
perform OFDM demodulation on said orthogonal frequency division access signal to generate demodulated spread samples;
despread said demodulated spread samples to generate symbol samples; and
iteratively detect user signals in said set of symbol samples.

24. A method of increasing the data rate within a wireless communication system adapted for transmitting a set of data streams to a set of users, said method comprising:
energy spreading each data stream from said set of data streams to generate a set of energy spread data streams;
time-frequency spreading said set of energy spread data streams using a set of orthogonal spreading codes to generate a set of spread spectrum data streams; and
placing said set of spread spectrum data streams into a set of frequency orthogonal carriers to generate an orthogonal frequency division access signal;
wherein at least said acts of energy spreading and time-frequency spreading reduce the bit error rate (BER) for a given value of E_{b}/N₀ for said transmitted data streams.
